(19) United States
(12) Patent Application Publication
(10) Pub. No.: US 2013/0090835 A1
(43) Pub. Date: Apr. 11, 2013

(54) CONSTRUCTION MACHINE

(71) Applicants: Hiroaki Take, Hiratsuka-shi (JP); Noritaka Nagata, Kamakura-shi (JP)

(72) Inventors: Hiroaki Take, Hiratsuka-shi (JP); Noritaka Nagata, Kamakura-shi (JP)

(73) Assignee: KOMATSU LTD., Tokyo (JP)

(21) Appl. No.: 13/638,983

(22) PCT Filed: May 13, 2011
(86) PCT No.: PCT/JP2011/061091

§ 371 Date: Dec. 10, 2012

(30) Foreign Application Priority Data
May 20, 2010 (JP) 2010-116804

(51) Int. Cl. F02D 41/00

(52) U.S. Cl. CPC F02D 41/00
USPC 701/103

(57) ABSTRACT

A construction machine storing a first torque diagram representing a region of a torque and a speed of the engine being able to be driven in a maximum torque region with respect to the engine speed and a second torque diagram in the first torque diagram, and controlling to change the engine speed on the second torque diagram by shifting from the first torque diagram to the second torque diagram based on an operation amount of an operation lever and/or a load applied and decrease the engine speed based on a decrease in load on the second torque diagram, the construction machine comprising: a controller stopping the engine control when a specific mode is selected and controlling so that the engine speed becomes a value in accordance with a setting amount of a fuel adjusting unit regardless of a change in the lever operation amount and/or the load applied.

### FIELD

The present invention relates to a construction machine including a driving source such as an engine, a power generator, and an electricity storage device.

### BACKGROUND

A construction machine such as a excavator which has been known from the past drives a hydraulic pump by using an engine such as a diesel engine as a driving source. A variable displacement type hydraulic pump is used as the hydraulic pump, and a capacity q (cc/rev) changes by changing an inclination angle of an inclination plate. Hydraulic oil which is discharged from the hydraulic pump is supplied to respective hydraulic actuators such as a boom cylinder through an operation valve. Since the hydraulic oil is supplied to the respective hydraulic actuators, the respective hydraulic actuators are driven, and an upper rotation body, a lower traveling body, and an operation unit having a boom, an arm, and a bucket connected to the respective hydraulic actuators are operated. A load which is applied to the operation unit, the lower traveling body, and the upper rotation body during the operation of the construction machine continually changes in response to a property of excavated soil, a slope of a traveling road, and the like. Accordingly, a load of a hydraulic unit (a hydraulic pump), that is, a load applied to the engine changes.

The control of the output P (horsepower; kw) of the engine is performed by adjusting the amount of fuel injected into a cylinder of the engine. The adjustment is performed by controlling a governor attached to a fuel injection pump of the engine. As the governor, an all speed control type governor is generally used, and the fuel injection amount is adjusted so that a target engine speed set by a fuel dial is maintained.

FIG. 10 illustrates a torque diagram of the engine, where a horizontal axis indicates an engine speed n (rpm; rev/min) and a vertical axis indicates a torque T (N·m). In FIG. 10, a region defined by a maximum torque line R indicates a performance which may be output by the engine. The governor controls the engine so that the torque T does not exceed a maximum torque line R and the engine speed n does not excessively rotate more than a high idle speed nH. The output P (horsepower) of the engine becomes maximal at a rated point V on the maximum torque line R. J indicates a constant horsepower curve in which the horsepower absorbed by the hydraulic pump becomes a constant horsepower.

When the target engine speed is set by the fuel dial, the governor performs speed control on a regulation line Fe connecting the rated point V and the high idle point nH.

As the load of the hydraulic pump increases, a matching point in which the output of the engine matches the pump absorption horsepower moves on the regulation line Fe toward the rated point V. When the matching point moves toward the rated point V, the engine speed n may gradually decreases, and the engine speed n becomes the rated speed at the rated point V.

When the operation is performed by fixing the engine speed n to an almost constant high speed in this way, there are problems that the fuel consumption amount is large and the pump efficiency is low. Furthermore, the fuel consumption amount indicates a fuel consumption amount per each output of 1 kW for 1 hour, and is an index of the efficiency of the engine. Further, the pump efficiency indicates the efficiency of the hydraulic pump which is defined by the volume efficiency and the torque efficiency.

In FIG. 10, M indicates a constant fuel curve. The fuel efficiency becomes minimal at M1 as the valley of the constant fuel curve M, and the fuel consumption amount as moves outward from the fuel efficiency minimum range M1.

As apparent from FIG. 10, the regulation line Fe is set as a region in which the fuel consumption amount is comparatively large on the constant fuel curve M. For this reason, according to the control method of the related art, the fuel consumption amount is large, and this is not desirable from the viewpoint of the engine efficiency.

On the other hand, in a case of the variable displacement type hydraulic pump, in general, the volume efficiency, the torque efficiency, and the pump efficiency become higher as the pump capacity q (the inclination plate inclination angle) becomes larger at the same discharge pressure.

Further, as apparent from Equation (1) below, when the flow rate Q of the pressure oil discharged from the hydraulic pump is constant, the pump capacity q may become larger as the speed n of the engine becomes lower. For this reason, when the engine becomes slower, the pump efficiency may become higher.

Q=n·q (1)

Accordingly, in order to improve the pump efficiency of the hydraulic pump, it is desirable to operate the engine in a low-speed region in which the engine speed n is low.

However, as apparent from FIG. 10, the regulation line Fe corresponds to a high-speed rotation region of the engine. For this reason, according to the control method of the related art, there is a problem that the pump efficiency is low.

As a control method of substantially fixing the engine speed regardless of the load, Patent Literature 1 discloses a control method of changing a engine speed in response to a lever operation amount and a load.

In Patent Literature 1, the target engine operation line L0 which passes the fuel efficiency minimum range M1 is set as illustrated in FIG. 10.

(Low-Speed Matching Control)

As illustrated in FIG. 10, when the speed of the engine is controlled along the target engine operation line L0 (the large line), the fuel consumption amount, the engine efficiency, and the pump efficiency are improved. This is because of the following reason. Even in a case where the same request flow rate is obtained by outputting the same horsepower, when the matching at the point pt2 which is a point on the constant horsepower line J and the target engine operation line L0 is performed rather than the matching at the point pt1 on the regulation line Fe, the state of the high rotation and the low torque is shifted to the state of the low rotation and the high torque, so that the pump capacity q becomes large and the operation is performed at a point close to the fuel efficiency minimum range M1 on the constant fuel curve M. Further, when the engine is operated at the low-speed rotation region, noise is reduced and there are advantages in the engine friction, the pump unloading loss, and the like.

Further, in the field of the construction machine, a hybrid type construction machine which assists a driving force of an engine by a power generating motor has been developed.

Further, a construction machine such as a excavator may perform various operations (various operation modes) such as a light load operation in which earth and sand are scooped and loaded on a dump truck or a heavy load operation in which solid stone is excavated. In order to attain the smaller fuel consumption amount more efficiently conducting the operation in accordance with the contents of the operations, the construction machine is equipped with a function of controlling the engine and the hydraulic pump of the control machine in response to the operation mode selected by the operation of the operator.

### CITATION LIST

### Patent Literature

Patent Literature 1: Japanese Patent Application Laid-open No. 2007-120426

### SUMMARY

### Technical Problem

Here, when the construction machine adopting the low-speed matching control of the related art performs the low-speed matching control on all operation modes, the fuel consumption amount, the engine efficiency, and the pump efficiency may be improved. However, for example, if the low-speed matching control is performed when selecting an operation mode such as a lifting mode in which a lifting is hung by a hook of a front end portion of an arm, is raised, and is carried by moving the arm and a boom of a excavator, the engine speed and the pump speed largely change with an increase and a decrease in load. Then, in accordance with this change, the engine sound and the pump sound change. Then, the change in sound gives an unpleasant operation sensation to the operator. Further, the movement of the operation unit or the like of the construction machine changes in accordance with a large change in the speed of the engine, and this also gives an unpleasant sensation to the operator. That is, in the low-speed matching control, the operation is performed in response to the operation amount of the operation lever, but since the engine sound and the pump sound largely change, the operator recognizes a change in the sound as a change in the operation state, and hence memorizes an operation sensation and an unpleasant sensation in the actual operation state.

The invention is made in view of the above-described circumstances, and it is an object to provide a construction machine which does not give an unpleasant sensation to an operator when performing a specific mode such as a lifting mode.

### Solution to Problem

To overcome the problems and achieve the object, according to the present invention, a construction machine including an engine, and configured to store a first torque diagram representing a region of a torque and a speed of the engine being able to be driven in a maximum torque region with respect to an engine speed of the engine and a second torque diagram present in the first torque diagram, and perform engine control to change the engine speed on the second torque diagram by shifting from the first torque diagram to the second torque diagram in response to a lever operation amount of an operation lever for operating the construction machine and/or a load applied to the construction machine and decrease the engine speed in response to a decrease in load on the second torque diagram, the construction machine comprises: a controller configured to stop the engine control when a specific mode is selected among a plurality of predetermined operation modes and perform control so that the engine speed becomes a value in accordance with a setting amount of a fuel adjusting unit regardless of a change in the lever operation amount and/or the load applied to the construction machine.

According to the present invention, the second torque diagram is a diagram which passes a fuel consumption amount minimum range of the engine.

According to the present invention, the specific mode includes a lifting mode which is selected during a lifting operation using an operation unit provided in the construction machine.

According to the present invention, the construction machine, further comprises: a display device configured to display various information items related to an operation state of the construction machine on a monitor screen and input an operation instruction to the construction machine.

According to the present invention, the display device is configured to display a selection screen used to select various operation modes including the specific mode on the monitor screen and output a selection signal of one selected operation mode to the controller.

### Advantageous Effects of Invention

According to the invention, since the controller performs the normal control in which the engine rotates at the engine speed in accordance with the setting amount of the fuel adjusting unit regardless of a change in load by stopping the low-speed matching control when the specific mode is selected among a plurality of predetermined operation modes, in a case where the operation of the specific mode is performed, a change in the engine speed and the pump speed decreases, so that a change in the engine sound and the pump sound decreases. Accordingly, it is possible to perform the operation without giving an unpleasant operation sensation to the operator.

### BRIEF DESCRIPTION OF DRAWINGS

FIG. 1 is a diagram illustrating an external configuration of a construction machine as a first embodiment of the invention.

FIG. 2 is a block diagram illustrating an entire configuration of the construction machine illustrated in FIG. 1.

FIG. 3 is a perspective view illustrating an external configuration of a driver seat illustrated in FIG. 1.

FIG. 4 is a diagram illustrating an example of an operation mode selection screen.

FIG. 5 is a torque diagram illustrating a relation between an engine torque and an engine speed in a case where low-speed matching control and normal control are performed.

FIG. 6 is a flowchart illustrating a control process procedure by a controller with an operation mode selection.

FIG. 7 is a diagram illustrating an external configuration and a function of a slot dial.

FIG. 8 is a block diagram illustrating an entire configuration of a construction machine as a second embodiment of the invention.

FIG. 9 is a block diagram illustrating an entire configuration of a construction machine as a third embodiment of the invention.

FIG. 10 is a torque diagram of an engine when low-speed matching control is performed.

### DESCRIPTION OF EMBODIMENTS

Hereinafter, referring to the drawings, a construction machine as a mode for carrying out the invention will be described. Furthermore, the invention is not limited to the embodiments.

### First Embodiment

(Entire Configuration)

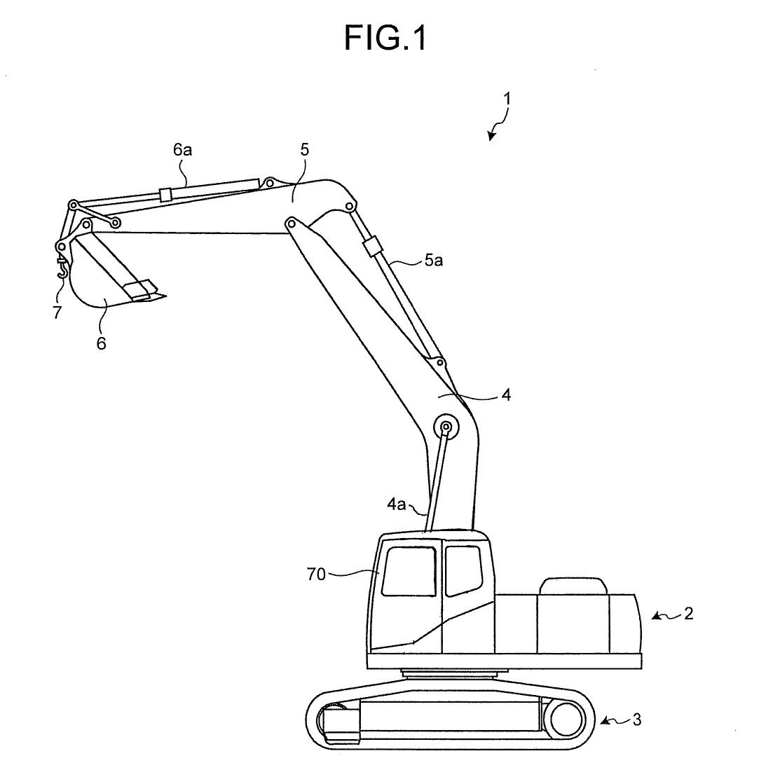

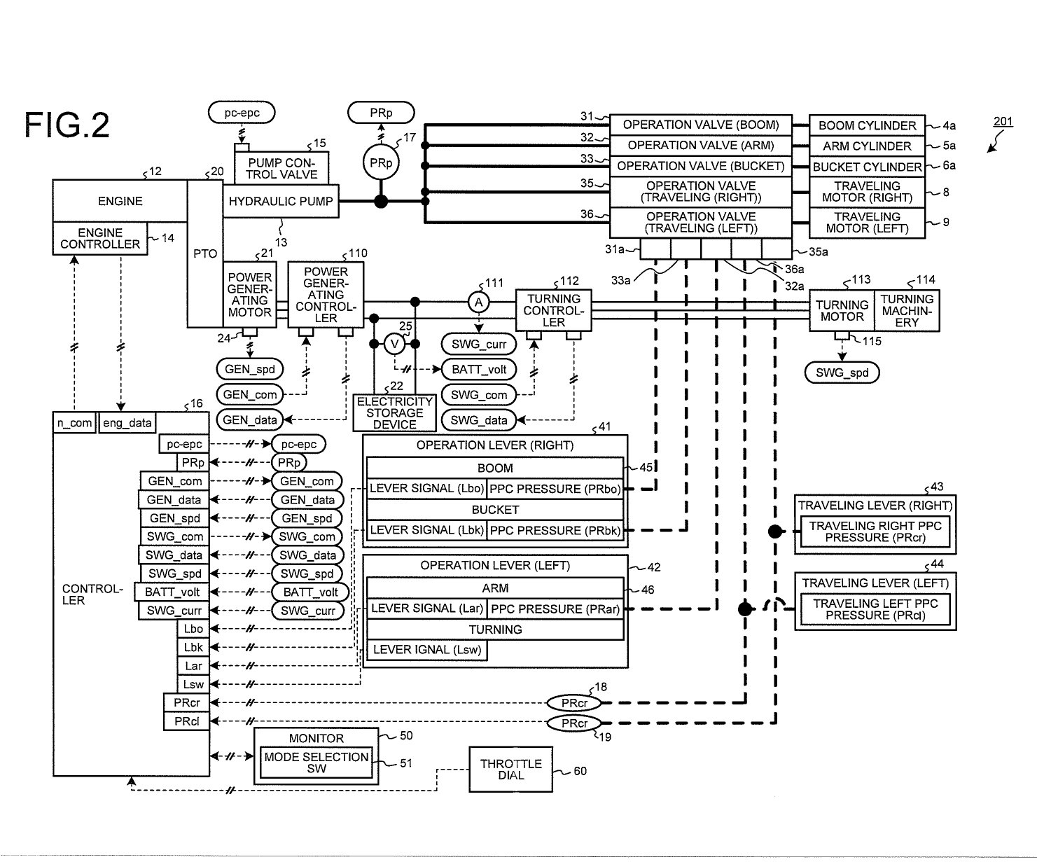

FIG. 1 is a diagram illustrating an external configuration of a construction machine 1 as a first embodiment of the invention. Further, FIG. 2 is a block diagram illustrating an entire configuration of the construction machine 1 illustrated in FIG. 1. Furthermore, the construction machine 1 is a excavator.

In FIGS. 1 and 2, the construction machine 1 includes an upper rotation body 2 and a lower traveling body 3, and the lower traveling body 3 includes left and right crawler tracks. An operation unit including a boom 4, an arm 5, and a bucket 6 is mounted on the upper rotation body 2. The boom 4 is operated by driving a boom cylinder 4a, the arm 5 is operated by driving an arm cylinder 5a, and the bucket 6 is operated by driving a bucket cylinder 6a. Furthermore, a hook 7 for hanging a suspended load is attached to a pin of a link connecting the bucket 6 and the arm 5 to each other. Further, the lower traveling body 3 includes traveling motors 8 and 9, and the right crawler track and the left crawler track respectively rotate by the respective driving operations thereof. When turning machinery 114 is driven by electrically driving a turning motor 113 through a turning controller 112, the upper rotation body 2 turns through a swing pinion, a swing circle, and the like.

A engine 12 is a diesel engine, and the control of the output (horsepower; kw) is performed by adjusting the amount of fuel injected into a cylinder. This adjustment is performed by controlling a governor attached to a fuel injection pump of the engine 12, and an engine controller 14 performs the control of the engine including the control of the governor. Furthermore, a throttle dial 60 is a fuel adjusting dial which serves as a fuel adjusting unit that defines the maximum fuel injection amount.

A controller 16 outputs a rotation instruction value for making an engine speed as a target speed n_com to the engine controller 14, and the engine controller 14 increases or decreases a fuel injection amount so as to obtain an engine target speed n_com by a target torque line L1. The target torque line L1 is stored as a data table format in a storage unit (not illustrated), and is a function in which a target absorption torque Tpcom of a hydraulic pump 13 increases with an increase in the engine speed n_com. Further, the engine controller 14 outputs engine data eng_data including an engine torque estimated from the engine speed and the fuel injection amount of the engine 12 to the controller 16.

The driving shaft of the hydraulic pump 13 is connected to the output shaft of the engine 12 through a PTO shaft 20, and the hydraulic pump 13 is driven by the rotation of the engine output shaft. The hydraulic pump 13 is a hydraulic pump of a variable displacement type, and the capacity q (cc/rev) changes with a change in the inclination angle of the inclination plate according to an operation of a pump control valve 15. Furthermore, the hydraulic pump 13 may be a double pump or a tandem pump.

The pressure oil which is discharged from the hydraulic pump 13 at a discharge pressure PRp and a flow rate Q (cc/min) is supplied to each of a boom operation valve 31, an arm operation valve 32, a bucket operation valve 33, a right traveling operation valve 35, and a left traveling operation valve 36. The pump discharge pressure PRp of the hydraulic pump 13 is detected by a hydraulic sensor 17, and a hydraulic pressure detection signal is input to the controller 16.

The respective hydraulic oils discharged from the operation valves 31, 32, 33, 35, and 36 are supplied to the boom cylinder 4a, the arm cylinder 5a, the bucket cylinder 6a, the right traveling motor 8, and the left traveling motor 9. Accordingly, the boom cylinder 4a, the arm cylinder 5a, the bucket cylinder 6a, the traveling motor 8, and the traveling motor 9 are respectively driven, and the boom 4, the arm 5, the bucket 6, the right and left crawler tracks of the lower traveling body 3 are operated.

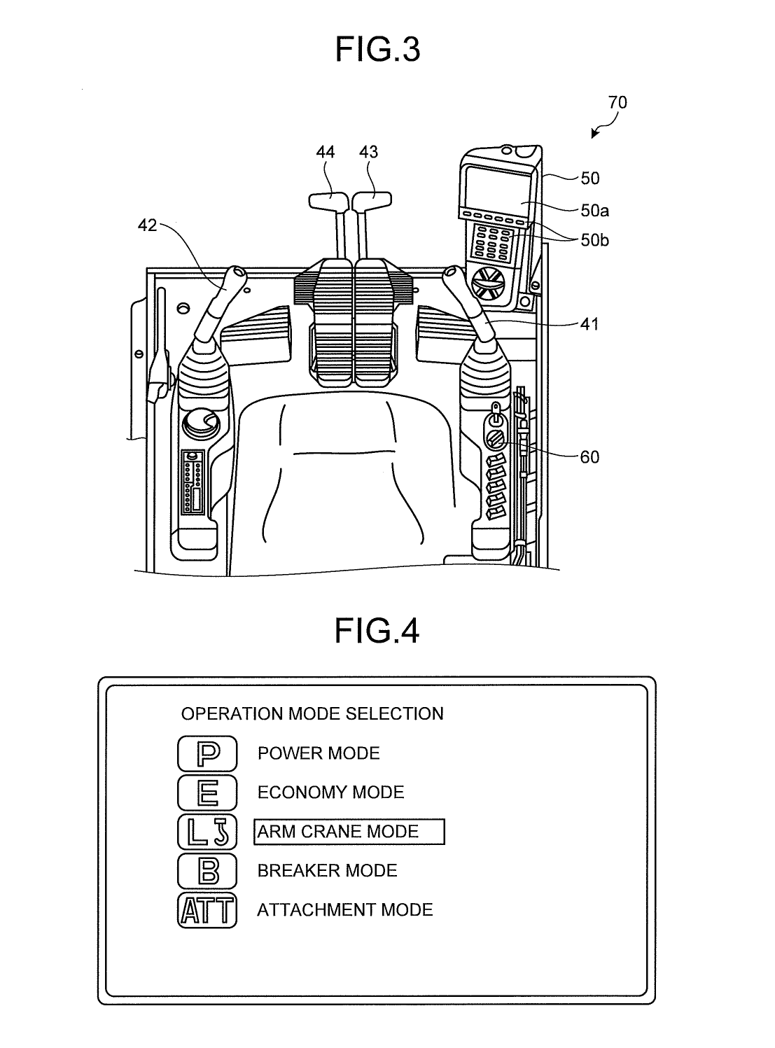

As illustrated in FIG. 3, a right operation lever 41 for operating an operation unit and a left operation lever 42 for turning the operation unit are respectively installed at the right side and the left side in front of the driver seat of the construction machine 1, and a right operation lever 43 for operating a traveling operation and a left operation lever 44 for operating a traveling operation are respectively installed.

The right operation lever 41 for operating the operation unit is an operation lever which operates the boom 4 and the bucket 6, operates the boom 4 and the bucket 6 in response to the operation direction, and operates the boom 4 and the bucket 6 at a speed in response to the operation amount.

The operation lever 41 is provided with a sensor 45 which detects the operation direction and the operation amount. The sensor 45 inputs a lever signal representing the operation direction and the operation amount of the operation lever 41 to the controller 16. In a case where the operation lever 41 is operated in a direction to operate the boom 4, a boom lever signal Lb0 representing a boom raising operation amount and a boom lowering operation amount in response to the operation direction and the operation amount with respect to the neutral position of the operation lever 41 is input to the controller 16. Further, in a case where the operation lever 41 is operated in a direction to operate the bucket 6, a bucket lever signal Lbk representing a bucket excavating operation amount and a bucket dumping operation amount in response to the operation direction and the operation amount with respect to the neutral position of the operation lever 41 is input to the controller 16.

In a case where the operation lever 41 is operated in a direction to operate the boom 4, a pilot pressure (PPC pressure) PRbo in response to the operation amount of the operation lever 41 is added to a pilot port 31a corresponding to the operation direction (the boom raising direction and the boom lowering direction) of the operation lever among the respective pilot ports of the boom operation valve 31.

Similarly, in a case where the operation lever 41 is operated in a direction to operate the bucket 6, a pilot pressure (PPC pressure) PRbk in response to the oblique movement amount of the operation lever 41 is added to a pilot port 33a corresponding to the lever oblique movement direction (the bucket excavating direction and the bucket dumping direction) among the respective pilot ports of the bucket operation valve 33.

The left operation lever 42 for turning the operation unit is an operation lever which operates the arm 5 and the upper rotation body 2, operates the arm 5 and the upper rotation body 2 in response to the operation direction, and operates the arm 5 and the upper rotation body 2 at a speed corresponding to the operation amount.

The operation lever 42 is provided with a sensor 46 which detects the operation direction and the operation amount. The sensor 46 inputs a lever signal representing the operation direction and the operation amount of the operation lever 42 to the controller 16. In a case where the operation lever 42 is operated in a direction to operate the arm 5, an arm lever signal Lar representing an arm excavating operation amount and the arm dumping operation amount in response to the operation direction and the operation amount with respect to the neutral position of the operation lever 42 is input to the controller 16. Further, in a case where the operation lever 42 is operated in a direction to operate the upper rotation body 2, a turning lever signal Lsw representing a right turning operation amount and a left turning operation amount in response to the operation direction and the operation amount with respect to the neutral position of the operation lever 42 is input to the controller 16.

In a case where the operation lever 42 is operated in a direction to operate the arm 5, a pilot pressure (PPC pressure) PRar in response to the operation amount of the operation lever 42 is added to a pilot port 32a corresponding to the operation direction (the arm excavating direction and the arm dumping direction) of the operation lever among the respective pilot ports of the arm operation valve 32.

On the other hand, in a case where the operation lever 42 is operated in a direction to operate the upper rotation body 2, the turning lever signal Lsw corresponding to the operation amount (the right turning direction and the left turning direction) of the operation lever 42 is input to the controller 16, and the controller 16 outputs a turning signal SWG_com corresponding to the turning lever signal Lsw to the turning controller 112, so that the turning motor 113 is rotationally driven.

The right operation lever 43 which operates the traveling operation and the left operation lever 44 which operates the traveling operation are operation levers which respectively operate the right crawler track and the left crawler track, the crawler track is operated in response to the operation direction, and the crawler track is operated at a speed corresponding to the operation amount.

A pilot pressure (PPC pressure) PRcr corresponding to the operation amount of the operation lever 43 is added to a pilot port 35a of the right traveling operation valve 35. Similarly, a pilot pressure (PPC pressure) PRcl corresponding to the operation amount of the operation lever 44 is added to a pilot port 36a of the left traveling operation valve 36.

The pilot pressure PRcr and the pilot pressure PRcl are respectively detected by hydraulic sensors 18 and 19, and are input to the controller 16.

A monitor 50 is a display device which is connected to the controller 16 so as to display and output various information items and perform an input operation, and includes a mode selection switch 51 which selects various operation modes. Furthermore, the monitor 50 is disposed at the right side of the front portion of a driver seat 70, has an external appearance illustrated in FIG. 3, and includes a monitor screen 50a. FIG. 4 illustrates an operation mode selection screen displayed on the monitor screen 50a. The operation mode selection screen of FIG. 4 is displayed by changing the screen with the pressing of several switches or buttons of an input unit 50b. In FIG. 4, icons respectively having characters of “P” of a P mode (a power mode), “E” of an E mode (an economy mode), “L” of an L mode (an arm crane mode=a lifting mode), “B” of a B mode (a breaker mode), and “ATT” of an ATT mode (an attachment mode) are displayed, and the titles of the respective modes are displayed at the right side thereof. Furthermore, regarding the L mode, a shape of a hook is displayed inside the icon so as to easily perceive the lifting mode. Here, for example, when the operation mode selection switch 51 of the input unit 50b is operated and the icon of the L mode is selected, a mode selection state is displayed by highlighting the character of the arm crane mode.

The respective operation valves 31, 32, 33, 35, and 36 are flow rate direction control valves, move spools in a direction corresponding to the operations directions of the corresponding operation levers 41 to 44, and move the spools so that oil passageways are opened by the opening areas corresponding to the operation amounts of the operation levers 41 to 44.

The pump control valve 15 is operated by a control current pc-epc output from the controller 6, and the pump control valve 15 is operated through a servo piston.

The controller 16 outputs a rotation instruction value to the engine controller 14 including the governor, and adjusts the speed n and the torque T of the engine 12 by increasing or decreasing the fuel injection amount so as to obtain the engine target speed corresponding to the load of the current hydraulic pump 13.

On the other hand, the output shaft of the engine 12 is connected to the driving shaft of the hydraulic pump 13 and the driving shaft of a power generating motor 21 through the PTO shaft 20. The power generating motor 21 performs a power generating operation and an electrical actuation. That is, the power generating motor 21 is operated as electrical machinery (a motor), and is also operated as a generator. In FIG. 2, the PTO shaft 20 is installed between the engine 12 and the hydraulic pump 13 or the power generating motor 21, but the output shaft of the engine 12 and the rotor shaft of the power generating motor 21 may be coaxially provided, and the rotor shaft of the power generating motor 21 and the input shaft of the hydraulic pump 13 may be coaxially provided. That is, the engine 12, the power generating motor 21, and the hydraulic pump 13 may be arranged in series. Furthermore, the embodiment may be implemented without using the PTO shaft 20.

The torque of the power generating motor 21 is controlled by the inverter function inside a power generating controller 110. The inverter function controls the torque of the power generating motor 21 in response to a power generating motor instruction value GEN_com output from the controller 16.

The power generating controller 110 is electrically connected to an electricity storage device 22 through a DC power line. Furthermore, the power supply of the controller 16 may be the electricity storage device 22 or the other electricity storage device (not illustrated).

The electricity storage device 22 includes a capacitor, an accumulator, or the like, and accumulates (charges) the power generated when the power generating motor 21 generates power. Further, the electricity storage device 22 supplies the power accumulated in the electricity storage device 22 to an inverter 23. Furthermore, in the embodiment, a capacitor (for example, an electrical double layer capacitor) accumulating charges by capacitance or an accumulator such as a lead battery, a nickel hydride battery, and a lithium ion battery is also referred to as the “electricity storage device”.

The power generating motor 21 is provided with a rotation sensor 24 which detects the current actual speed GEN_spd (rpm) of the power generating motor 21, that is, the actual speed of the engine 12. A signal representing the actual speed GEN_spd detected by the rotation sensor 24 is input to the controller 16.

Further, the electricity storage device 22 is provided with a voltage sensor 25 which detects a voltage BATT_volt of the electricity storage device 22. A signal representing the voltage BATT_volt detected by the voltage sensor 25 is input to the controller 6.

Further, the controller 16 outputs the power generating motor instruction value GEN_com to the power generating controller 110, and performs a power generating operation or an electrical actuation of the power generating motor 21. When the instruction value GEN_com for allowing the power generating motor 21 to be operated as a generator is output from the controller 16 to the power generating controller 110, a part of the output torque generated by the engine 12 is transmitted to the driving shaft of the power generating motor 21 through the PTO shaft 20 and power is generated by absorbing the torque of the engine 12. Then, AC power generated by the power generating motor 21 is converted into DC power by the power generating controller 110, and the power is accumulated (charged) in the electricity storage device 22.

Further, when the power generating motor instruction value GEN_com for allowing the power generating motor 21 to be operated as a motor is output from the controller 16 to the power generating controller 110, the power generating controller 110 performs control so that the power generating motor 21 is operated as a motor. That is, power is output (discharged) from the electricity storage device 22, the DC power accumulated in the electricity storage device 22 is converted into the AC power by the power generating controller 110, and the power is supplied to the power generating motor 21, thereby rotating the driving shaft of the power generating motor 21. Accordingly, a torque is generated by the power generating motor 21, the torque is transmitted to the PTO shaft 20 through the driving shaft of the power generating motor 21, and is added to the output torque of the engine 12 (the output of the engine 12 is assisted). The added output torque is absorbed by the hydraulic pump 13.

The power generating amount (the absorbed torque amount) and the electrical actuation amount (the assist amount; the generated torque amount) of the power generating motor 21 change in response to the contents of the power generating motor instruction value GEN_com.

The power generating controller 110 performs the speed control or the torque control of the power generating motor 21. Here, the speed control is control in which the speed of the power generating motor 21 is adjusted so as to obtain a target speed by giving a target speed as a power generating motor instruction value GEN_com to the power generating motor 21. Further, the torque control is control in which the torque of the power generating motor 21 is adjusted so as to obtain a target torque by giving a target torque as a power generating motor instruction value GEN_com to the power generating motor 21.

In a case where the controller 16 performs the speed control, when a difference between the engine target speed and the actual speed of the engine 12 becomes a predetermined threshold value or more, assist control is performed by sending a power generating motor instruction value GEN_com for assisting the engine 12 by the power generating motor 21 to the power generating controller 110.

In a case where the assisting of the power generating motor 21 is performed, the engine 12 is accelerated. In this case, since there is the assisting of the power generating motor 21, the absorption torque of the hydraulic pump 13 increases at the initial step of increasing the rotation of the engine compared to a case without any assisting. For this reason, the operation unit moves fast with respect to the movement of the operation lever, and degradation in the operation efficiency may be suppressed, thereby reducing an unpleasant operation sensation given to an operator.

The construction machine 1 is configured to turn the upper rotation body 2 by the electric actuator (the electric turning motor 113).

That is, as illustrated in FIG. 2, the construction machine 1 includes a component for turning the upper rotation body 2 by the turning motor 113 as the electric actuator, that is, the power generating motor controller 110, a current sensor 111, the turning controller 112, the turning motor 113, and a turning speed sensor 115.

Here, the engine torque assisting operation will be defined. The engine torque assisting operation indicates that a torque is added to the engine output shaft by the power generating motor 21 so that the engine actual speed fast reaches the target speed when the governor or the fuel injection pump is adjusted so that the speed of the engine 12 becomes a certain target speed. Here, the “addition of the torque” includes not only a case where the shaft torque is added so as to increase the speed fast when accelerating the rotation of the engine, but also a case where the shaft torque is absorbed so as to decrease the speed fast when decelerating the rotation of the engine.

That is, in the first embodiment, the engine torque assisting operation corresponds to that the engine 12 is assisted by causing the power generating motor 21 to perform an electrical actuation and the engine 12 is reversely assisted by causing the power generating motor 21 to perform a power generating operation.

As for the effect of the engine torque assisting operation, when accelerating the rotation of the engine, the responsiveness of the acceleration of the engine becomes satisfactory and the workability is improved, and when decelerating the rotation of the engine, the engine speed decreases fast by the absorption of the engine shaft torque and the noise or the vibration when decelerating the engine speed is improved. Further, since the engine shaft torque is absorbed when decreasing the engine speed, the rotation energy of the inertia about the engine output shaft may be absorbed, and hence there is an effect that the energy efficiency is improved.

Here, the “case were the engine torque assisting operation is not performed” indicates that the energy (power) is supplied to the electricity storage device 22 by allowing the power generating motor 21 to perform the power generating operation or the power is directly supplied to the turning motor 113 so as to allow the upper rotation body 2 to perform the electrical actuation.

The control whether to perform the engine torque assisting operation or not to perform the engine torque assisting operation is performed by the power generating controller 110 and the turning controller 112 based on the instruction from the controller 16.

Then, as illustrated in FIG. 2, the turning motor 113 as the electric motor is connected to the driving shaft of the turning machinery 114, the turning machinery 114 is driven by driving the turning motor 113, and the upper rotation body 2 turns through the swing pinion, the swing circle, and the like.

The turning motor 113 performs the power generating operation and the electrical actuation. That is, the turning motor 113 is operated as the motor, and is also called the generator. In a case where the turning motor 113 is operated as the motor, the upper rotation body 2 turns, and when stopping the turning of the upper rotation body 2, the torque of the upper rotation body 2 is absorbed and the turning motor 113 serves as the generator.

The driving of the turning motor 113 is controlled by the turning controller 112. The turning controller 112 is electrically connected to the electricity storage device 22 through a DC power line, and is electrically connected to the power generating motor 110. The power generating controller 110 has the function of the inverter 13. The turning controller 112 and the power generating controller 110 are controlled in response to the instruction output from the controller 16.

The current which is supplied to the turning motor 113, that is, the turning load current SWG_curr representing the load of the upper rotation body 2 is detected by the current sensor 111. The turning load current SWG_curr which is detected by the current sensor 111 is input to the controller 16.

Then, as described above, in a case where the operation lever 42 is operated in a direction to operate the upper rotation body 2, the turning lever signal Lsw corresponding to the operation amount (the right turning direction and the left turning direction) of the operation lever 42 is input to the controller 16, and the controller 16 outputs the turning signal SWG_com corresponding to the turning lever signal Lsw to the turning controller 112, so that the turning motor 113 is driven to turn.

(Control by Mode Selection)

The operator may select the operation mode corresponding to the operation contents by pressing the input unit 50b of the monitor 50 installed inside the driver seat 70 of the construction machine 1. A selection signal corresponding to the selected operation mode is output to the controller 16. Furthermore, the mode selection switch 51 may be provided in the input unit 50b, but the display unit 50a may be configured as a touch panel type liquid crystal screen. Then, the operation mode may be selected by causing the operator to press a part of the screen.

First, the operation mode which is selected by the mode selection switch 51 includes the P mode (the power mode), the E mode (the economy mode), the L mode (the lifting mode), the B mode (the breaker mode), and the ATT mode (the attachment mode). The P mode or the E mode is a mode when the normal excavating operation or the like is performed, and in the E mode, the maximum torque is suppressed compared to the P mode. The L mode is a minute operation mode in which the construction machine slowly moves by suppressing the engine speed (at a medium speed) as in the arm crane operation or the like in which the suspended load hung by the hook 7 is lifted. The B mode is a mode in which the operation is performed by attaching a breaker for breaking stone or the like as an attachment, and is a mode in which the operation is performed by setting the engine speed as the medium high speed. The ATT mode is a mode in which the operation is performed during a time in which the engine speed changes from the medium speed to the high speed, and is a preliminary mode in a case where a specific attachment such as grapples is attached. When the mode selection switch 51 is operated by the operator so that several operation modes are selected, a selection signal corresponding to the selected operation mode is output to the controller 16.

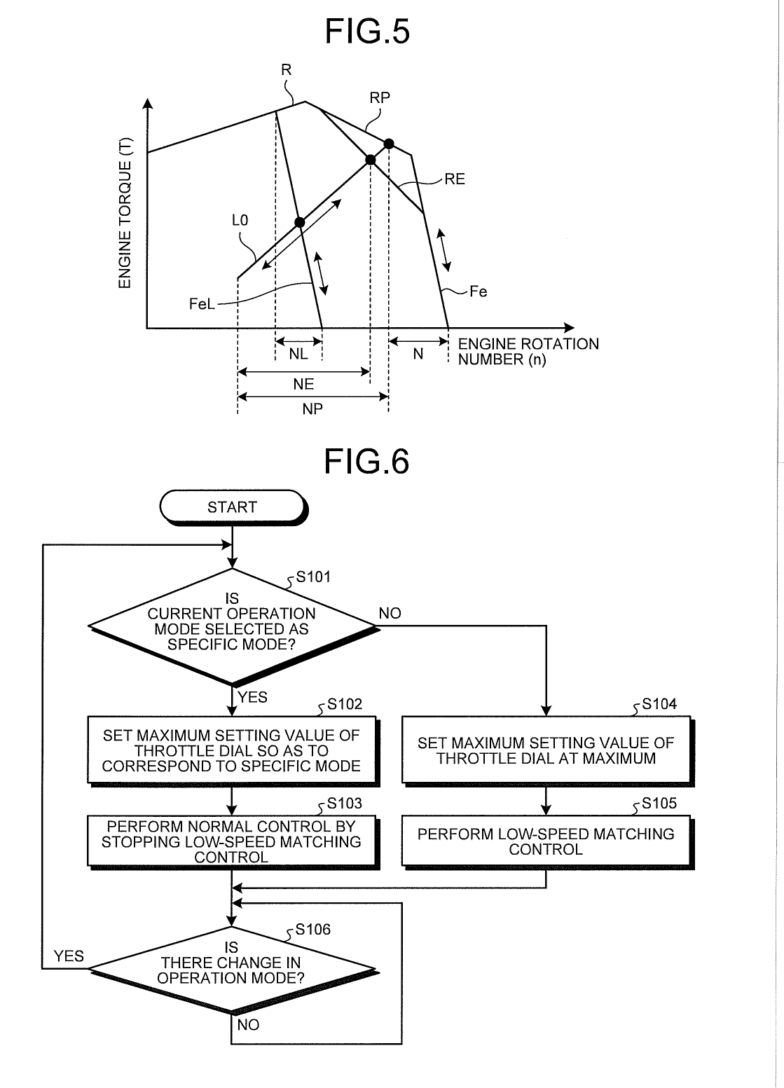

Here, when the P mode and the E mode are selected by the operator, the controller 16 of the construction machine 1 performs low-speed matching control in which the engine speed and the engine torque are controlled so as to follow a target engine operation line L0 (a second torque diagram) of an engine torque diagram illustrating a relation between the engine torque and the engine speed illustrated in FIG. 5. On the other hand, in a case where the other modes, that is, the L mode and the B mode as the specific modes are selected, the controller 16 does not perform the low-speed matching control and performs the normal control in which the engine speed with the operation of the operation levers 41 and 42 becomes substantially constant. For example, in a case of the L mode, the engine is controlled so as to follow the medium-speed regulation line Fel determined by the setting value of the throttle dial 60. Furthermore, in a case of the E mode, the mode is present in a range that does not exceed the maximum torque line RE (the other first torque diagram) in which the maximum torque is further limited compared to the maximum torque line RP (the first torque diagram) at the P mode, and in a case where the target engine operation line L0 illustrated in FIG. 5 is set as the P mode, the engine 12 is controlled by the lower torque (the other second torque diagram) on the target engine operation line L0. Here, in a case of the low-speed matching control is performed, the engine is driven on the maximum torque line RP (or RE), and the engine speed changes from the maximum torque line RP (or RE) to the target engine operation line L0 (the second torque diagram) in response to the operation lever or the load.

Further, in the B mode and the ATT mode, any control of the low-speed matching control and the normal control may be performed if there is no unpleasant operation sensation, but there is a need to set the control to be performed when any operation mode is selected. Even in a case where the B mode is selected, the breaker is operated by a constant operation and hence does not give an unpleasant sensation to the operator. For this reason, it is desirable to perform the normal control in which the low-speed matching control is not performed.

Further, even in a case of a hoeing operation as an operation for flatting a ground by the bucket 6, a slope surface operation for forming a slope surface by the bucket 6, a slope surface running operation, and the like, it is considered that the operator needs to pay attention to the operation. Accordingly, as in the L mode, it is desirable to set the operation mode in which the normal control is performed. The L mode is an operation mode which is selected when accurately and slowly moving the operation unit for the lifting operation, the hoeing operation, and the like, and the minute operation mode may be selected instead of the lifting mode. That is, the specific mode indicates the operation mode when accurately and slowly operating the operation unit for the lifting mode, the B mode, the minute operation mode, and the like.

Furthermore, the target engine operation line L0 as the second torque diagram is a diagram which passes the fuel consumption amount minimum range of the engine 12, but the invention is not limited thereto. The other target engine operation line as the other second torque diagram which does not pass the fuel consumption amount minimum range of the engine 12 may be provided, and control may be performed in which the engine speed decreases in response to a reduction of the load on the other target engine operation line. That is, the low-speed matching control mentioned in the embodiment is not necessarily limited to a case where the control is performed on the target engine operation line passing the fuel consumption amount minimum range, but the engine speed may be decreased in response to a reduction of the load. This is because the fuel consumption amount may be suppressed by decreasing the engine speed in response to a reduction of the load. Furthermore, in FIG. 5, the second torque diagram intersects the first torque diagram, but the invention is not limited thereto. The second torque diagram does not intersect the first torque diagram.

As illustrated in FIG. 5, the engine speed change amount N in a case where the low-speed matching control is not performed and the control is performed by the regulation line Fe and the engine speed change amount NL in a case of the L mode as the specific mode are smaller than the engine speed change amounts NP and NE in the case of the P mode and the E mode in which the low-speed matching control is performed, so that the engine speed becomes substantially constant.

That is, in a case where the P mode and the E mode are selected by the operator, the controller 16 performs the low-speed matching control so that the fuel consumption amount, the engine efficiency, and the pump efficiency are improved. On the other hand, in a case where the specific mode including the L mode is selected, the low-speed matching control in which the engine speed largely changes with respect to a change in engine torque is not performed, and the normal control in which the engine speed becomes substantially constant with respect to a change in engine torque is performed. Accordingly, even when the load largely changes, the engine sound and the pump sound does not change, the operator does not feel unpleasant during the operation, and the sense of anxiety of the operator and the peripheral operator may be suppressed. Further, it is possible to suppress that the movement of the operation unit of the construction machine changes due to a large change in the speed of the engine and the operator feels unpleasant.

Here, referring to the flowchart illustrated in FIG. 6, the control process using the controller 16 will be described. First, it is determined whether the current operation mode selected by the mode selection switch 51 is the specific mode (step S101). In a case of the specific mode (Yes in step S101), the maximum setting value using the throttle dial 60 is set so as to correspond to the specific mode (step S102). For example, in a case where the specific mode is the L mode, the maximum setting value is set as the medium speed.

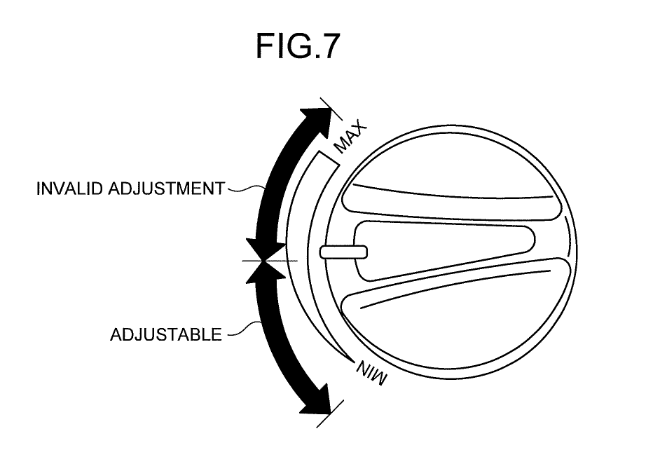

As a result, the throttle dial value becomes the minimum value of the maximum setting value and the current setting value. That is, as illustrated in FIG. 7, the throttle dial value may be increased by rotating the throttle dial 60 in the clockwise direction. Then, as described above, in a case where the L mode is selected, the maximum setting value is set to the medium speed. Accordingly, even when the throttle dial 60 is turned to the medium speed or more, the fuel adjustment is not valid, and hence the fuel adjustment may be performed to the medium speed by the throttle dial value.

Subsequently, the controller 16 stops the low-speed matching control and performs the normal control (step S103). For example, in a case where the specific mode is the L mode, the engine speed is controlled on the regulation line FeL illustrated in FIG. 5.

On the other hand, in a case where the operation mode selected by the operator through the mode selection switch 51 is not the specific mode (No in step S101), that is, the P mode, the E mode, or the like, the maximum setting value of the throttle dial 60 is maximally set (step S104). Subsequently, the low-speed matching control is performed (step S105), and the engine speed is controlled on the target engine operation line L0. Subsequently, it is determined whether the operation mode is changed (step S106), and when there is an instruction for changing the operation mode (Yes in step S106), the routine proceeds to step S101 so as to repeat the above-described process. On the other hand, when there is no instruction for changing the operation mode (No in step S106), the determination process of step S106 is repeated, and the state of the current operation mode is maintained.

In the first embodiment, when the specific modes are set in advance as the operation mode in which the low-speed matching control is performed and the operation mode in which the low-speed matching control is not performed and the normal control in which the engine is controlled at the substantially constant engine speed and the specific modes are selected, the engine speed does not largely change with a change in load, and the speed of the hydraulic pump corresponding thereto does not largely change. Accordingly, since the engine sound and the pump sound do not largely change, the operation efficiency may be improved without giving an unpleasant operation sensation to the operator. Further, it is possible to suppress that the movement of the operation unit or the like of the construction machine changes by a large change in the speed of the engine and the operator feels unpleasant. Further, in the first embodiment, the operation amounts of the operation levers 41 to 44 are detected as the electrical signal, but the invention may be also applied to a hydraulic pilot type operation lever. That is, the invention may be applied to a configuration in which a PPC (Pressure Proportional Control) pressure corresponding to an operation amount of an operation lever is supplied to an operation valve and the operation valve controls the supply of oil to a hydraulic actuator such as the boom cylinder 4a of the operation unit.

### Second Embodiment

In the first embodiment described above, the construction machine has been described which is equipped with the electric turning system that turns the upper rotation body 2 of the construction machine 1 by the electric actuator (the turning motor 113), but in a second embodiment, a construction machine 201 which turns the upper rotation body 2 by a hydraulic actuator (a hydraulic motor) is exemplified.

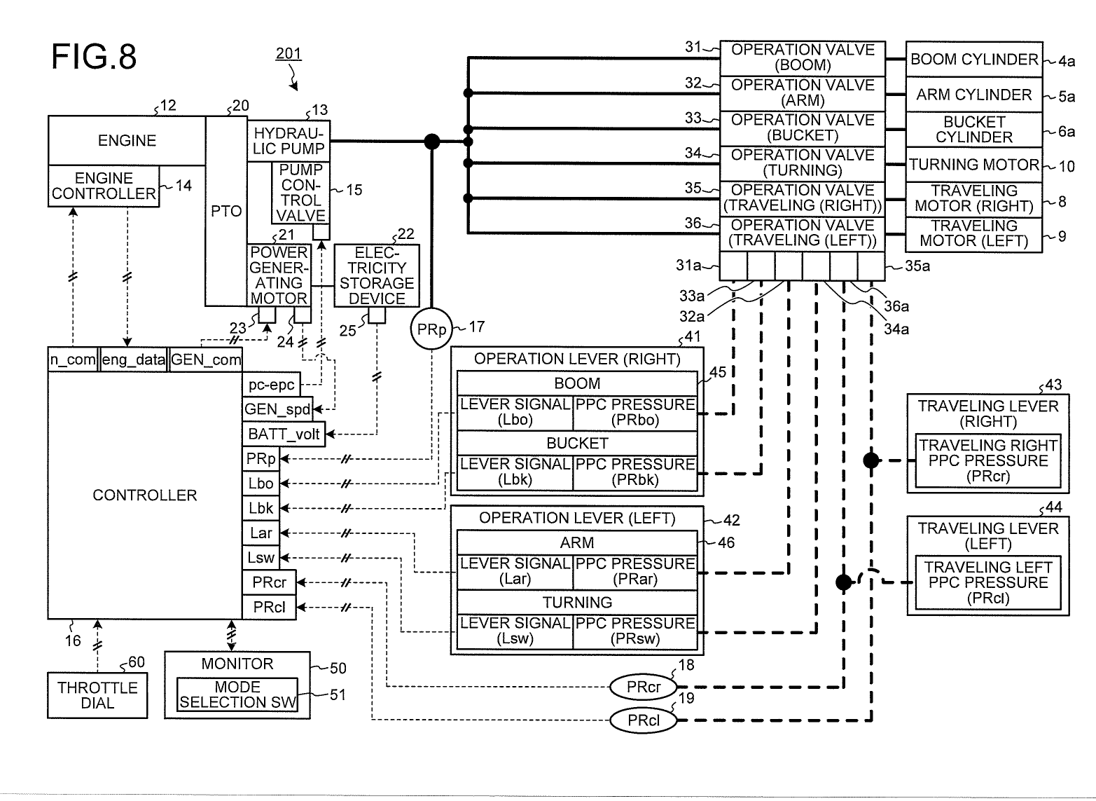

FIG. 8 is a block diagram illustrating a schematic configuration of the construction machine 201 as the second embodiment of the invention, and as illustrated in FIG. 8, the construction machine 201 includes a turning motor 10 as a hydraulic motor and a turning operation valve 34 instead of the components for turning the upper rotation body 2 by the electric actuator (the turning motor 113) illustrated in FIG. 2. Furthermore, the inverter 23 only having an inverter function is provided instead of the power generating motor controller 110.

In a case where the operation lever 42 is operated in a direction to operate the upper rotation body 2, a pilot pressure (PPC pressure) PRsw corresponding to the operation amount of the operation lever 42 is added to a pilot port 34a corresponding to the operation direction (the right turning direction and the left turning direction) of the operation lever in the pilot ports of the turning operation valve 34. Accordingly, the turning operation valve 34 is operated, and the turning motor 10 is operated, so that the upper rotation body 2 turns.

In the second embodiment, the construction machine which turns the upper rotation body 2 by the hydraulic actuator is provided instead of the construction machine which turns the upper rotation body 2 by the electric actuator (the electric motor). However, whether the low-speed matching control will be performed so as to correspond to the selected operation mode or whether the normal control will be performed by disabling the low-speed matching control is controlled as in the first embodiment. Further, in the second embodiment, the operation amounts of the operation levers 41 to 44 are detected as the electrical signal, but the invention may be also applied to the hydraulic pilot type operation lever. That is, the invention may be applied to a configuration in which a PPC (Pressure Proportional Control) pressure corresponding to the operation amount of the operation lever is supplied to the operation valve and the operation valve controls the supply of oil to the hydraulic actuator such as the boom cylinder 4a of the operation unit.

### Third Embodiment

In the first and second embodiments described above, the construction machine is driven by using the engine 12, but in a third embodiment, an electric construction machine 301 which drives the hydraulic pump 13 using a motor 212 instead of the engine 12 is provided.

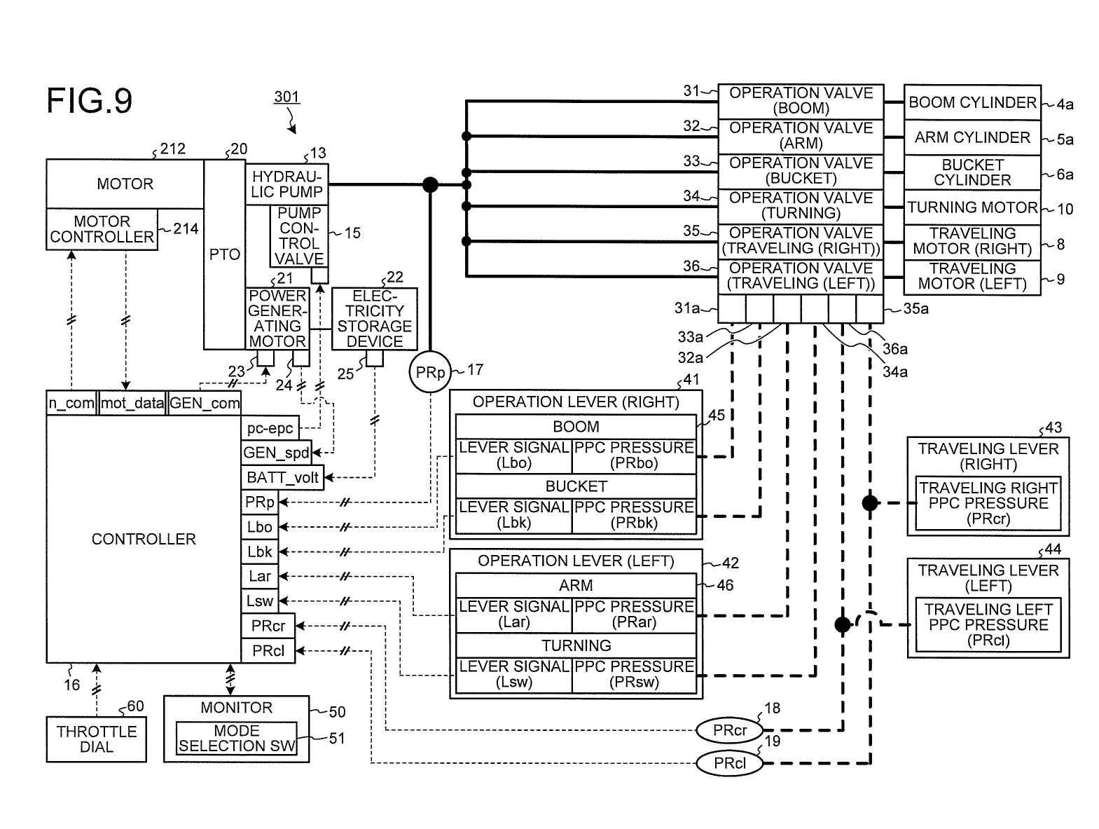

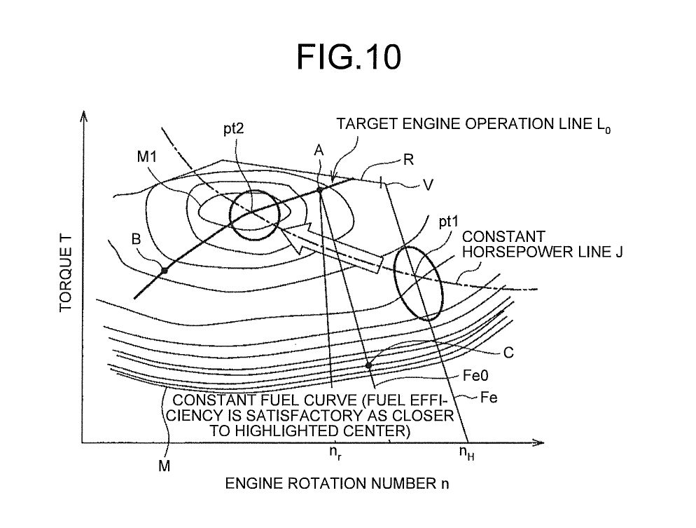

FIG. 9 is a block diagram illustrating a schematic configuration of the construction machine 301 as the third embodiment of the invention. The construction machine 301 is equipped with the motor 212 instead of the engine 21, and includes a motor controller 214 which controls the rotation of the motor 212 instead of the engine controller 14. Furthermore, the throttle dial 60 is used to adjust the current amount instead of the fuel injection amount. The other configurations are the same as those of the first embodiment.

Then, the controller 16 performs the low-speed matching control or the normal control based on the selection result of the operation mode by controlling the motor speed instead of the engine speed. In this case, since a change in the speed of the hydraulic pump 13 is small in the specific mode, a change in the pump sound is small, the operator does not feel unpleasant during the operation, and the operation efficiency may be improved. Furthermore, the third embodiment may be also applied to the second embodiment. Further, in the third embodiment, on the assumption that the traveling motors 8 and 9 or the lower traveling body 3 is provided, the traveling operation may be performed to a certain extent, but the invention is not limited thereto. A configuration may be adopted in which the lower traveling body 3 such as the traveling motors 8 and 9 enabling the self running operation is not provided.

Furthermore, in the above-described embodiments, a so-called hybrid construction machine has been described which performs the engine torque assisting operation, the hydraulic pump assisting operation, or the electric motor driving operation using the electricity storage device 22, but the invention is not limited thereto. The invention may be also applied to a construction machine which does not use the electricity storage device 22, the power generating motor 21, or the like and performs the low-speed matching control using a driving source such as one engine.

### REFERENCE SIGNS LIST

1, 201, 301 CONSTRUCTION MACHINE

2 UPPER ROTATION BODY

3 LOWER TRAVELING BODY

4 BOOM

4a BOOM CYLINDER

5 ARM

5a ARM CYLINDER

6 BUCKET

6a BUCKET CYLINDER

7 HOOK

8, 9 TRAVELING MOTOR

10 TURNING MOTOR

12 ENGINE

13 HYDRAULIC PUMP

14 ENGINE CONTROLLER

15 PUMP CONTROL VALVE

16 CONTROLLER

17 to 19 HYDRAULIC SENSOR

20 PTO SHAFT

21 POWER GENERATING MOTOR

22 ELECTRICITY STORAGE DEVICE

23 INVERTER

24 ROTATION SENSOR

25 VOLTAGE SENSOR

31 to 36 OPERATION VALVE

31a to 36a PILOT PORT

41 to 44 OPERATION LEVER

45, 46 SENSOR

50 MONITOR

50a DISPLAY UNIT

50b INPUT UNIT

51 MODE SELECTION SWITCH

52 MONITOR SCREEN

60 THROTTLE DIAL

70 DRIVER SEAT

110 POWER GENERATING MOTOR CONTROLLER

111 CURRENT SENSOR

112 TURNING CONTROLLER

113 TURNING MOTOR

115 TURNING SPEED SENSOR

212 MOTOR

214 MOTOR CONTROLLER

1. A construction machine including an engine, and configured to store a first torque diagram representing a region of a torque and a speed of the engine being able to be driven in a maximum torque region with respect to an engine speed of the engine and a second torque diagram present in the first torque diagram, and perform engine control to change the engine speed on the second torque diagram by shifting from the first torque diagram to the second torque diagram in response to a lever operation amount of an operation lever for operating the construction machine and/or a load applied to the construction machine and decrease the engine speed in response to a decrease in load on the second torque diagram, the construction machine comprising:
a controller configured to stop the engine control when a specific mode is selected among a plurality of predetermined operation modes and perform control so that the engine speed becomes a value in accordance with a setting amount of a fuel adjusting unit regardless of a change in the lever operation amount and/or the load applied to the construction machine.

2. The construction machine according to claim 1,
wherein the second torque diagram is a diagram which passes a fuel consumption amount minimum range of the engine.

3. The construction machine according to claim 1,
wherein the specific mode includes a lifting mode which is selected during a lifting operation using an operation unit provided in the construction machine.

4. The construction machine according to claim 1, further comprising:
a display device configured to display various information items related to an operation state of the construction machine on a monitor screen and input an operation instruction to the construction machine.

5. The construction machine according to claim 4,
wherein the display device is configured to display a selection screen used to select various operation modes including the specific mode on the monitor screen and output a selection signal of one selected operation mode to the controller.
